(19) United States
(12) Patent Application Publication
(10) Pub. No.: US 2013/0175220 A1
(43) Pub. Date: Jul. 11, 2013

(54) TITANIUM DIOXIDE-BASED HYBRID ION-EXCHANGE MEDIA

(71) Applicants: Kiril D. Hristovski, Mesa, AZ (US); Paul K. Westerhoff, Scottsdale, AZ (US)

(72) Inventors: Kiril D. Hristovski, Mesa, AZ (US); Paul K. Westerhoff, Scottsdale, AZ (US)

(21) Appl. No.: 13/738,160

(22) Filed: Jan. 10, 2013

Related U.S. Application Data
(60) Provisional application No. 61/585,144, filed on Jan. 10, 2012.

(51) Int. Cl. B01J 20/30; C02F 1/42; B01J 20/26

(52) U.S. Cl. CPC B01J 20/3078; B01J 20/26; C02F 1/42
USPC 210/670; 252/184; 210/683; 210/684

(57) ABSTRACT

A titanium dioxide-based hybrid ion-exchange media including anatase titanium dioxide nanoparticles supported by an ion-exchange resin for removing strong acid ions and oxo-anions from water. The titanium dioxide-based hybrid ion-exchange media is prepared in situ by combining ion-exchange media with a TiO²⁺ precursor solution to form a mixture and heating the mixture to yield the hybrid ion-exchange media.

### CROSS-REFERENCE TO RELATED APPLICATIONS

This application claims priority to U.S. Application Ser. No. 61/585,144, filed on Jan. 10, 2012 and entitled “TITANIUM DIOXIDE-BASED HYBRID ION-EXCHANGE MEDIA,” which is incorporated by reference herein in its entirety.

### TECHNICAL FIELD

This invention is related to titanium dioxide-based hybrid ion-exchange media for removing strong acid ions and oxo-anions from water.

### BACKGROUND

Arsenic and nitrate are known groundwater contaminants. Relatively low-cost hybrid ion-exchange media capable of simultaneous removal of strong acid anions such as nitrate and oxo-anions such as arsenate (+5) and arsenite (+3) have been formed by combining iron (hydr)oxide and strong base ion-exchange media. The oxo-anions are understood to adsorb onto metal surfaces by forming stable inner-sphere bidentate ligands. The use and regeneration of iron (hydr)oxide hybrid media are limited, however, by the dissolution iron (hydr)oxide at low pH and its affinity for silica at high pH.

### SUMMARY

In one aspect, ion-exchange media and a TiO²⁺ precursor solution are combined to form a mixture, and the mixture is heated to yield a hybrid ion-exchange media including titanium dioxide.

Implementations may include one or more of the following features. In some cases, the TiO²⁺ precursor solution is a titanium oxosulfate solution. The ion-exchange media is a strong base or weak base ion-exchange media. The hybrid ion-exchange media includes titanium dioxide particles formed in situ and supported by the ion-exchange media. The titanium dioxide particles include titanium dioxide nanoparticles such as, for example, anatase titanium dioxide nanoparticles.

Some embodiments include preparing the TiO²⁺ precursor solution before combining the ion-exchange media and the TiO²⁺ precursor solution. In certain cases, the mixture is decanted and the ion-exchange media is rinsed after decanting. The hybrid ion-exchange media may be rinsed, and the rinsed hybrid ion-exchange media may be combined with a salt solution. The salt solution may be rinsed from the hybrid ion-exchange media.

In another aspect, a hybrid ion-exchange media having anatase titanium dioxide nanoparticles formed thereon is contacted with an aqueous solution including an oxo-anion, a strong acid anion, or both, thereby removing the oxo-anion, the strong acid anion, or both from the aqueous solution.

In some implementations, the oxo-anion includes arsenate, arsenite, or phosphate and the strong acid anion includes nitrate or perchlorate. Contacting the hybrid ion-exchange media with hydrochloric acid regenerates the hybrid ion-exchange media, thereby yielding regenerated hybrid ion-exchange media. The regenerated hybrid ion-exchange media is completely regenerated with respect to the strong acid anion. When the aqueous solution includes silica, the regenerated hybrid ion exchange media is completely regenerated with respect to silica.

In yet another aspect, a hybrid ion-exchange media includes anatase titanium dioxide nanoparticles formed in situ in pores of strong base or weak base ion-exchange media.

The hybrid ion-exchange media is formed by a process including combining the ion-exchange media and a TiO²⁺ precursor solution to form a mixture, and heating the mixture to yield the hybrid ion-exchange media. The ion-exchange media may be coated with the anatase titanium dioxide nanoparticles. In some cases, the nanoparticles have a dimension between 50 nm and 90 nm. In certain cases, the specific surface area of the anatase titanium dioxide nanoparticles is at least 30 m²/g. A content of titanium in the anatase titanium dioxide nanoparticles is typically in a range between 5% and 15% per media dry mass. The Freundlich adsorption intensity parameter (l/n) of the hybrid ion-exchange media is <1, indicate good adsorption of arsenic. For example, the adsorption capacity for arsenic expressed per mass of titanium in the hybrid ion-exchange media is in a range between about 15 mg As/g Ti and about 30 mg As/g Ti. Moreover, the hybrid ion-exchange media is completely regenerable (e.g., at least 95%) with respect to nitrate and silica.

Advantages of the titanium dioxide-based hybrid ion-exchange media described herein include efficient and simultaneous sremoval of strong acid anions and oxo-anions from aqueous environments at a range of pH values characteristic of contaminated aqueous systems. Synthesis of the hybrid ion-exchange media is efficient, scalable, and cost-effective, and the ion-exchange capacity is not substantially reduced by impregnation with titanium dioxide. In addition, the hybrid ion-exchange media is completely regenerable in a one-step process (e.g., contacting with hydrochloric acid) with respect to certain species.

The details of one or more embodiments are set forth in the accompanying drawings and the description below. Other features, objects, and advantages will be apparent from the description and drawings, and from the claims.

### BRIEF DESCRIPTION OF THE DRAWINGS

The concepts herein may be more completely understood in consideration of the following detailed description of various embodiments in connection with the accompanying drawings, in which:

FIG. 1 is a flow chart showing a method for synthesizing a titanium dioxide-based hybrid ion-exchange media;

FIG. 2A is a scanning electron microscope image of the cross-section of a hybrid ion-exchange media bead;

FIG. 2B is a scanning electron microscope image of macropores of hybrid ion-exchange media coated with fused titanium dioxide nanoparticles;

FIG. 3 shows X-ray diffraction spectra of titanium dioxide inside hybrid ion-exchange media;

FIG. 4 shows a bar graph showing percent titanium content for titanium dioxide-based hybrid ion-exchange media;

FIG. 5 is a Freundlich isotherm for arsenic showing arsenic adsorption capacity of titanium dioxide-based hybrid ion-exchange media;

FIG. 6 is a Freundlich isotherm for arsenic showing arsenic adsorption capacity of titanium dioxide-based hybrid ion-exchange media at different pH values;

FIG. 7 is a Freundlich isotherm for nitrate showing nitrate adsorption capacity of titanium dioxide-based hybrid ion-exchange media;

FIG. 8 shows nitrate removal breakthrough curves for virgin and regenerated titanium dioxide-based hybrid ion-exchange media;

FIG. 9 shows silica removal breakthrough curves for virgin and regenerated titanium dioxide-based hybrid ion-exchange media; and

FIG. 10 shows phosphate removal breakthrough curves for virgin and regenerated titanium dioxide-based hybrid ion-exchange media.

### DETAILED DESCRIPTION

Titanium dioxide (TiO₂)-based hybrid ion-exchange media synthesized as described herein (Ti-HIX) allow simultaneous removal of strong acid anions (e.g., nitrate, perchlorate) and oxo-anions (e.g., arsenate, arsenite, phosphate) from water. The Ti-HIX media is formed in an in-situ process that yields TiO₂ (e.g., anatase) supported by ion-exchange (IX) media. The IX media may be anion-selective IX media (e.g., strong base or weak base IX media) such as, for example, nitrate-selective media, perchlorate-selective media, vanadate-selective media, and the like. The TiO₂ on the IX media has a high specific surface area (e.g., greater than 30 m²/g), which is several times higher than conventional TiO₂ powder adsorbents. Adsorption of oxo-anions is promoted at least in part by the high specific surface area of the TiO₂ on the surface of the IX media.

Advantages of anatase Ti-HIX media include stability and catalytic activity of the TiO₂. The anatase TiO₂ can oxidize reduced oxo-anion species (e.g., oxidize arsenite to arsenate). This oxidation can result in species that have greater affinity for TiO₂. In an example, arsenate has a higher affinity for TiO₂ than phosphate, and phosphate has a higher affinity for TiO₂ than arsenite. TiO₂ also has a relatively low iso-electronic point that may be tailored towards improved selectivity and regeneration abilities.

Ti-HIX media described herein exhibit a titanium content in a range between about 5% and about 15% of the dry mass of the media. The Freundlich adsorption intensity parameter (l/n) for Ti-HIX media described herein is <1, indicating favorable adsorption for arsenic. The estimated maximum adsorption capacity for arsenic expressed per mass of titanium is in a range between about 15 mg As/g Ti and about 30 mg As/g Ti. Strong acid anion removal of the base ion-exchange resins used in the synthesis of the Ti-HIX media is not adversely impacted by the in situ synthesis of anatase nanoparticles on the media.

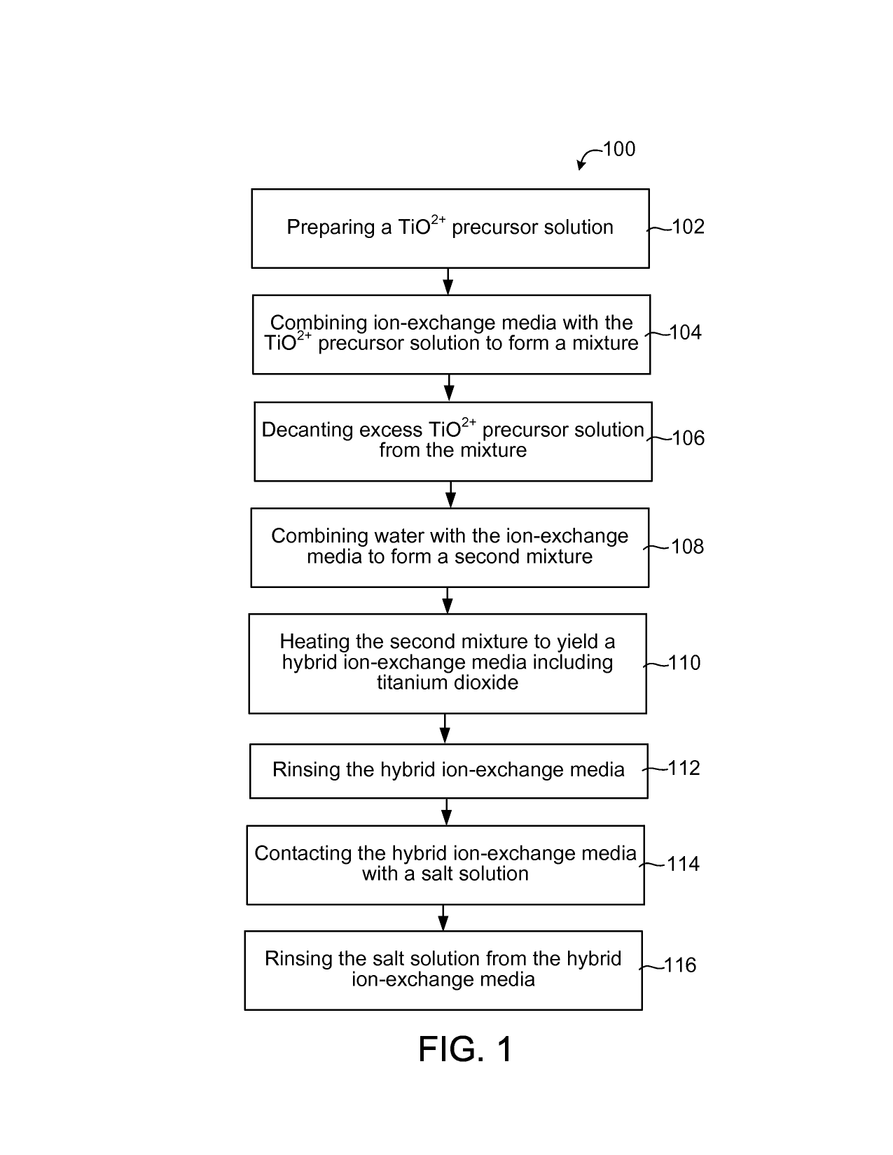

Process 100 for synthesizing a titanium dioxide-based HIX media is shown in FIG. 1. In 102, an aqueous TiO²⁺ precursor solution is prepared. The TiO²⁺ precursor solution may include any titanium oxo salt, such as titanium oxychloride (TiOCl₂), titanium oxysulfate (TiOSO₄), and the like, or any mixture thereof. In an example, the precursor solution is a saturated solution prepared at elevated temperature. The precursor solution is generally clear and devoid of particulate matter. In 104, wet ion-exchange (IX) media is mixed with the precursor solution. The mixing may occur in a closed vessel. In some cases, the IX media is presoaked in ultrapure water for a length of time ranging from minutes to hours. The volume ratio of precursor solution to ion-exchange media can be in a range from 1:1 to 5:1 (e.g., from 2:1 to 3:1). In 106, the excess precursor solution is decanted. In 108, water (e.g., ultrapure water) is combined with the media. In 110, the mixture is heated to promote hydrolysis, and TiO₂ nanoparticles are formed on surfaces of the IX media, including within the pores thereof. Heating may occur, for example, in a closed vessel placed in a temperature-controlled environment (e.g., in a range from 70° C. to 90° C.) for a length of time (e.g., 12 to 36 hours). In 112, the prepared Ti-HIX media is rinsed (e.g., with ultrapure water) until the wash water is substantially free of TiO₂ particles. In 114, the rinsed Ti-HIX media is soaked in a sodium chloride solution (e.g., 5% NaCl) for a length of time (e.g., 12-36 hours) to convert the Ti-HIX media back to its chloride form. In 116, the Ti-HIX media is rinsed (e.g., with ultrapure water) to remove excess salt. The prepared Ti-HIX media can be stored wet before use.

In some cases, portions of process 100 are omitted or performed in an order other than that described with respect to FIG. 1. In one example, the mixture from 104 is heated as described with respect to 110, and the decanting and washing of 106 and 108, respectively, are omitted. In another example, the precursor solution may be obtained already prepared, such that 102 is omitted.

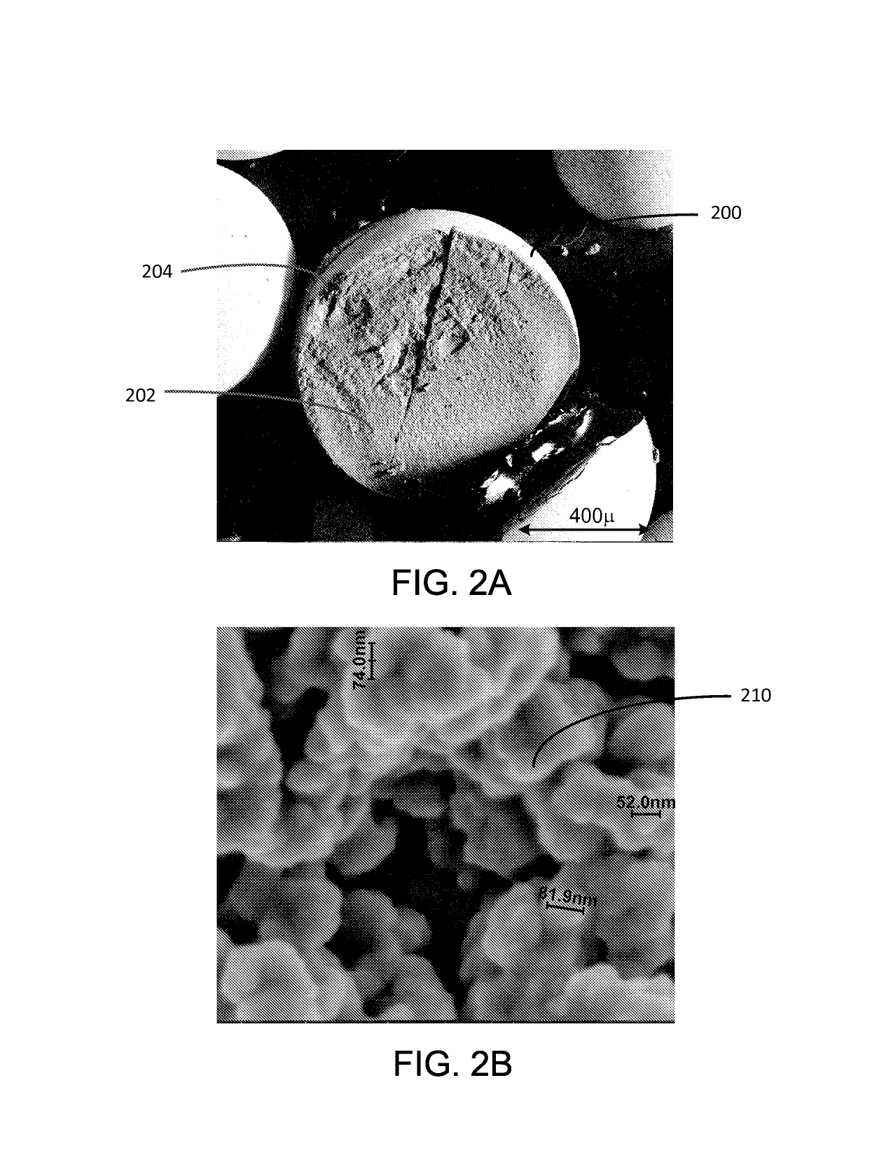

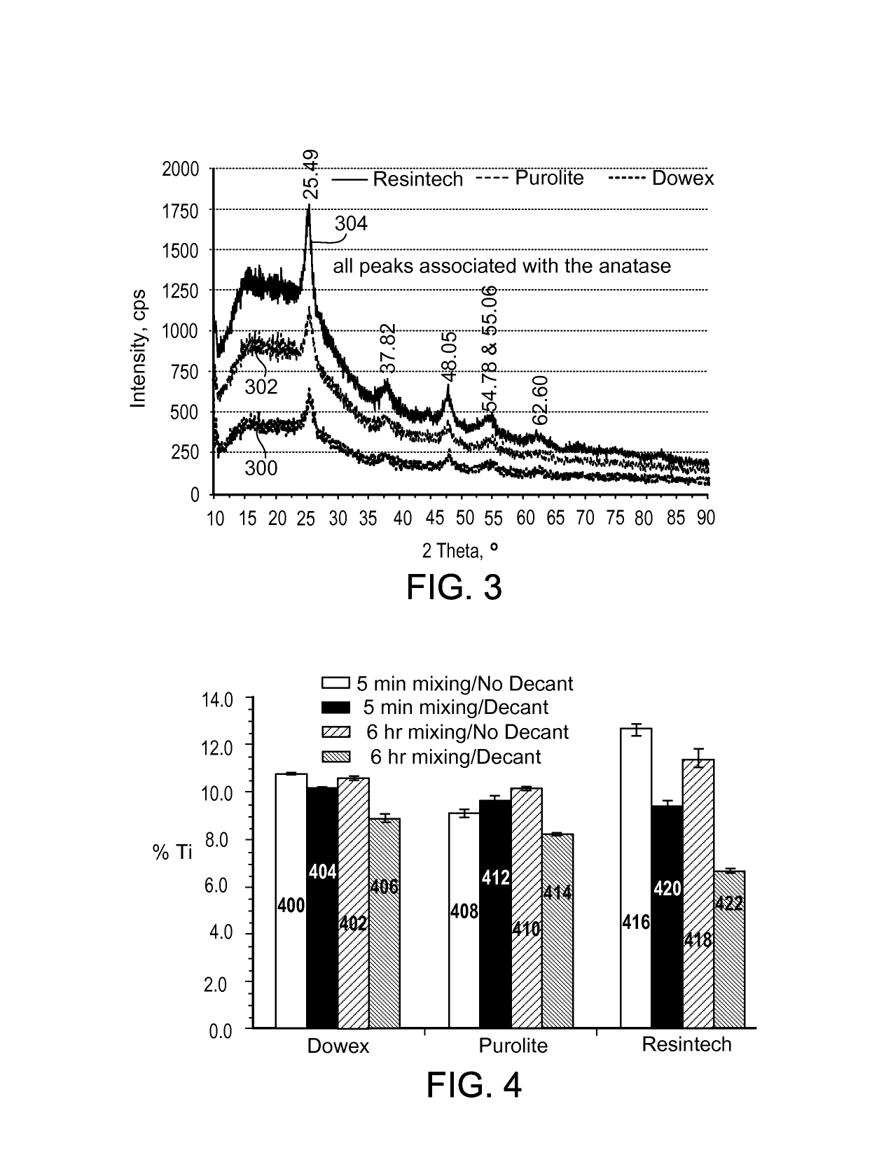

FIG. 2A shows a scanning electron microscope (SEM) image of a cross-section of a Ti-HIX media bead 200 prepared as described with respect to process 100 in FIG. 1. The media beads are typically between 400 and 800 μm in diameter. The backscatter detector used during the focused ion beam (FIB)/SEM analysis differentiates between heavier elements such as titanium, which appear as white areas 202 in the image, and lighter elements such as carbon, nitrogen, oxygen and hydrogen, which appear as darker areas 204 in the image. The apparently uniform distribution of whiter areas throughout the particle implies substantially even distribution of the titanium dioxide on the medium. FIG. 2B is a SEM image showing macropores inside the Ti-HIX media as substantially covered with clusters of (e.g., fused) titanium dioxide nanoparticles 210. The nanoparticles are typically spherical, and a dimension of the nanoparticles (e.g., a diameter) is in range between about 50 and 90 nm. FIG. 3 shows X-ray diffraction (XRD) spectra 300, 302, and 304 of titanium dioxide supported by IX media Dowex NSR-1 (Dow Chemical Co.), A-520E (Purolite), and SIR-100-HP (Resintech), respectively. The peaks seen in FIG. 3 are indicative of the anatase form of titanium dioxide, which imparts photocatalytic activity to the Ti-HIX media. The XRD data suggests that the IX resin has little or no impact on the crystalline structure of the TiO₂ nanoparticles.

Isotherms were developed for arsenic and nitrate adsorption and analyzed using the Freundlich adsorption model:

q=K×C_{E}^{l/n} (1)

in which q is the adsorption capacity, K is the Freundlich adsorption capacity parameter, C_{E} is the equilibrium concentration of adsorbate in solution, and l/n is the Freundlich adsorption intensity parameter. For arsenic, q is expressed as μg adsorbate/g adsorbent, K is expressed as μg adsorbate/g adsorbent×(L/μg adsorbate)^{l/n}, C_{E} is expressed as μg adsorbate/L, and l/n is the Freundlich adsorption intensity parameter (unitless). The adsorption capacity is expressed as μg adsorbate/g As, and the Freundlich adsorption capacity parameter is expressed as μg adsorbate/g As×(L/μg adsorbate)^{l/n}. For nitrate, q is expressed as mg adsorbate/g adsorbent, K is expressed as mg adsorbate/g adsorbent×(L/mg adsorbate)^{l/n}, C_{E} is expressed as mg adsorbate/L, and l/n is the Freundlich adsorption intensity parameter (unitless). The adsorption capacity is expressed as mg adsorbate/g NO₃, and the Freundlich adsorption capacity parameter is expressed as μg adsorbate/g NO₃×(L/mg adsorbate)^{l/n}.

Ti-HIX media prepared as described herein can be regenerated by contacting spent media with hydrochloric acid. Thus, the regeneration is a “one-step” process. During the regeneration process, the Ti-HIX media is capable of essentially complete regeneration for nitrate and silica. As described herein, “essentially complete regeneration” generally refers to removal of at least 95% of the amount of a species (e.g., oxo-anion) by a regenerated Ti-HIX media as compared to the comparable virgin Ti-HIX media.

### Example

### Media Synthesis

Three macroporous, strong base ion-exchange (IX) resins (Dowex NSR-1 (Dow Chemical Co.), A-520E (Purolite), and SIR-100-HP (Resintech)) were impregnated in situ with titanium dioxide nanomaterials. The resulting Ti-HIX resins were analyzed for percent titanium content by gravimetric analysis. Table 1 summarizes the physico-chemical properties of each of these anion-exchange resins.

TABLE 1
Anion-exchange media.

| | | | Exchange | Dp (mm) |
|---|---|---|---|---|
| | | Functional | capacity | (mesh size) |
| Media | Manufacturer | groups | (meq/mL) | as reported |
| Dowex | Dow | Quaternary | 1.4 | 0.3-1.2 |
| NSR-1 | Chemical Co. | amine | | (16-50) |
| A-520E | Purolite | Quaternary | 0.9 | 0.3-1.2 |
| | | ammonium | | (16-50) |
| SIR-100-HP | Resintech | R—N—R₃⁺Cl⁻ | 0.85 | 0.3-1.2 |
| | | | | (16-50) |

50 mL of each anion-exchange media was mixed with 100 mL of ultrapure water (<1 μS/cm) for 24 hours to expand the macropores of the media. The ultrapure water was then decanted and the excess water was removed.

A saturated solution of TiO²⁺ precursor was formed by incrementally dissolving 124 g TiOSO₄ in 100 mL of ultrapure water. To assist in dissolution, the mixture was placed into an 80±1° C. oven after each incremental addition of TiOSO₄. A decrease in pH to 2 to 3 was seen as TiOSO₄ dissociated to form TiO²⁺ and SO₄²⁻ in the ultrapure water.

Next, a 100 mL portion of saturated TiO²⁺ precursor solution prepared as described above was mixed with each IX media for the length of time indicated in Table 2. After mixing, the Group 3 and 4 mixtures were decanted. Preheated 80° C. ultrapure water was immediately added to cover the media of the Group 3 and 4 mixtures after decanting. Group 1-4 samples were sealed and placed in an 80±1° C. oven for 24 hours to facilitate hydrolysis of TiO²⁺, thereby forming TiO₂ as indicated by the following reaction:

TiO²⁺+2H₂O→TiO(OH)₂+2H⁺→TiO₂+H₂O (2)

TABLE 2
IX media and synthesis conditions.

| | | | No Decant or |
|---|---|---|---|
| | | | Decant of |
| | | Contact Time for | saturated so- |
| Group | | TiO²⁺ saturated | lution of |
| number | Media type | solution and media | TiO²⁺ precursor |
| Group 1 | Dowex, | 5 min Mixing | No Decant |
| | Purolite A-520E | | |
| | Resintech SIR-100-HP | | |
| Group 2 | Dowex, | 6 h Mixing | No Decant |
| | Purolite A-520E | | |
| | Resintech SIR-100-HP | | |
| Group 3 | Dowex, | 5 min Mixing | Decant, preheated |
| | Purolite A-520E | | 80° C. ultrapure |
| | Resintech SIR-100-HP | | water added |
| Group 4 | Dowex, | 6 h Mixing | Decant, preheated |
| | Purolite A-520E | | 80° C. ultrapure |
| | Resintech SIR-100-HP | | water added |

After 24 hours, the twelve samples shown in Table 2 were removed from the 80±1° C. oven, allowed to cool, and then decanted. Each sample was repeatedly rinsed with ultrapure water (<1 μS/cm) until the pH was 5-6 and until excess TiO²⁺ salt precursors were removed. Each synthesized medium was then regenerated with 5% NaCl solution for 2 days to convert the medium back to its chloride form. After the 2 days, each regenerated medium was repeatedly rinsed with ultrapure water to remove any excess NaCl, and the TiO₂ impregnated media were stored wet before use.

Gravimetric Analysis of Ti Content.

Three 50 mL beakers were obtained for each impregnated media. 6 to 7 g of impregnated media was added to each beaker, and each beaker was dried in a 103±2° C. oven to constant mass (within ±0.5 mg) to remove moisture. The mass of each dried impregnated media was calculated. The beakers were then placed in a 550° C. muffle furnace to ash each media to a constant mass (within ±0.5 mg) to remove any carbon content or impurities, and the mass of each ashed impregnated media was calculated. The percent titanium content for each medium was then calculated from the mass of the dried impregnated media and the mass of the ashed impregnated media for that sample as shown below.

% Ti=100×(mol fraction Ti in TiO₂)×(mass of ashed residue)/(mass of dried media)

FIG. 4 shows percent titanium content for each of the samples listed in Table 2. Dowex samples for Groups 1-4 are shown as 400, 402, 404, and 406, respectively. Purolite samples for Groups 1-4 are shown as 408, 410, 412, and 414, respectively. Resintech samples for Groups 1-4 are shown as 416, 418, 420, and 422, respectively. Error bars represent standard deviations. The Group 1 Resintech sample 416 (5 min mixing, no decantation) shows the highest percentage titanium content. However, shorter mixing times and decanting (e.g., Group 3 Dowex sample 404) are desirable for various reasons, including synthetic throughput and material savings associated with re-using the supernatant. Overall, the titanium dioxide content of the Ti-HIX media ranged between 11% (about 5% as Ti) and 21% (about 15% as Ti) by dry resin mass. In general, most of the Ti-HIX media were characterized with TiO₂ contents which were close to the average value of 16.4% (about 10% as Ti content).

The TiO₂ content data suggest that short mixing periods result in media with higher TiO₂ content. A mixing time of 6 hours without decanting the excess precursor solution resulted in similar TiO₂ contents as the 5 minute mixing times with or without decanting. However, when the excess precursor was decanted, the prolonged mixing of the media apparently resulted in lower TiO₂ content. Not to be bound by theory, the lower TiO₂ content is thought to be related at least in part to attrition of the IX resin and/or reequilibrium of the TiO²⁺ between the bulk solution and the pores of the IX resin. Higher metal (hydr)oxide content typically relates to higher adsorption capacity of the metal (hydr)oxide impregnated media. When the metal (hydr)oxide contents of the media are similar or higher at shorter mixing times, these shorter mixing times can be implemented to lower fabrication costs in large scale processes. Additionally, reusing the excess precursor solution for fabrication of other Ti-HIX media further can reduce the cost of production, making the Ti-HIX media fabricated by mixing the IX resin for 5 minutes and decanting the excess precursor more economically advantageous than other alternatives.

Characterization of Media.

Arsenic content of the media was determined by mass spectrometer (X Series ICP-MS mass spectrometer) according to EPA Method 200.8. Before analysis, concentrated nitric acid and hydrochloric acid were added to each sample. Nitrate content was analyzed by ion chromatography (Dionex model: ICS-2000) according to EPA 300.0. Samples were filtered with 0.45 μm polyethersulfone filters prior to analysis.

The structure and distribution of TiO₂ throughout finely powdered samples of the synthesized media were evaluated by X-ray diffraction analysis (PANalytical X′Pert Pro, CuKα source). Focused ion beam (FIB) scanning electron microscopy (Nova 200 NanoLab UHR FEG-SEM/FIB) was used to determine the size and the shape of the TiO₂ within the macropores of the synthesized media. Results are shown in FIGS. 2A and 2B and described with respect thereto. The surface area and pore size distribution of the samples were measured using the Brunauer, Emmett, Teller (BET) method (Micrometrics Tristar-II 3020 automated gas adsorption analyzer). The surface charge and isoelectric points were analyzed by measuring the zeta potential (PALS Zeta Potential Analyzer, Brookhaven Instruments Corporation, Holtsville, N.Y.) at different pH values in 10 mM KNO₃ background electrolyte solution. The solution pH was adjusted by the dropwise addition of 0.1 M or 1 M HNO₃ solution.

Equilibrium Adsorption Experiments.

Batch arsenic and nitrate adsorption experiments were conducted for the Ti-HIX samples of Group 1 (5 min mixing, no decantation) and the three IX media shown in Table 1. Experiments were conducted in 0.10 L amber glass bottles at a target pH of 7.7±0.3. Nitric acid and sodium hydroxide were used to adjust the pH of the buffered ultrapure water to the target pH. Two 5 mM NaHCO₃ buffered solutions (<1 μS/cm) were used in these experiments: (1) for arsenic, impregnated samples were mixed with solutions of 5 mM NaHCO₃ in buffered ultrapure water containing an initial concentration C₀=120 μg/L As; and (2) for nitrate, impregnated samples were mixed with solutions of 5 mM NaHCO₃ buffered ultrapure water containing an initial concentration C₀=5 mg/L NO₃⁻. Samples were continuously agitated for 3 days prior to measurement of adsorbent dosages. Each medium was separated out by gravity prior to the addition of concentrated nitric and hydrochloric acid.

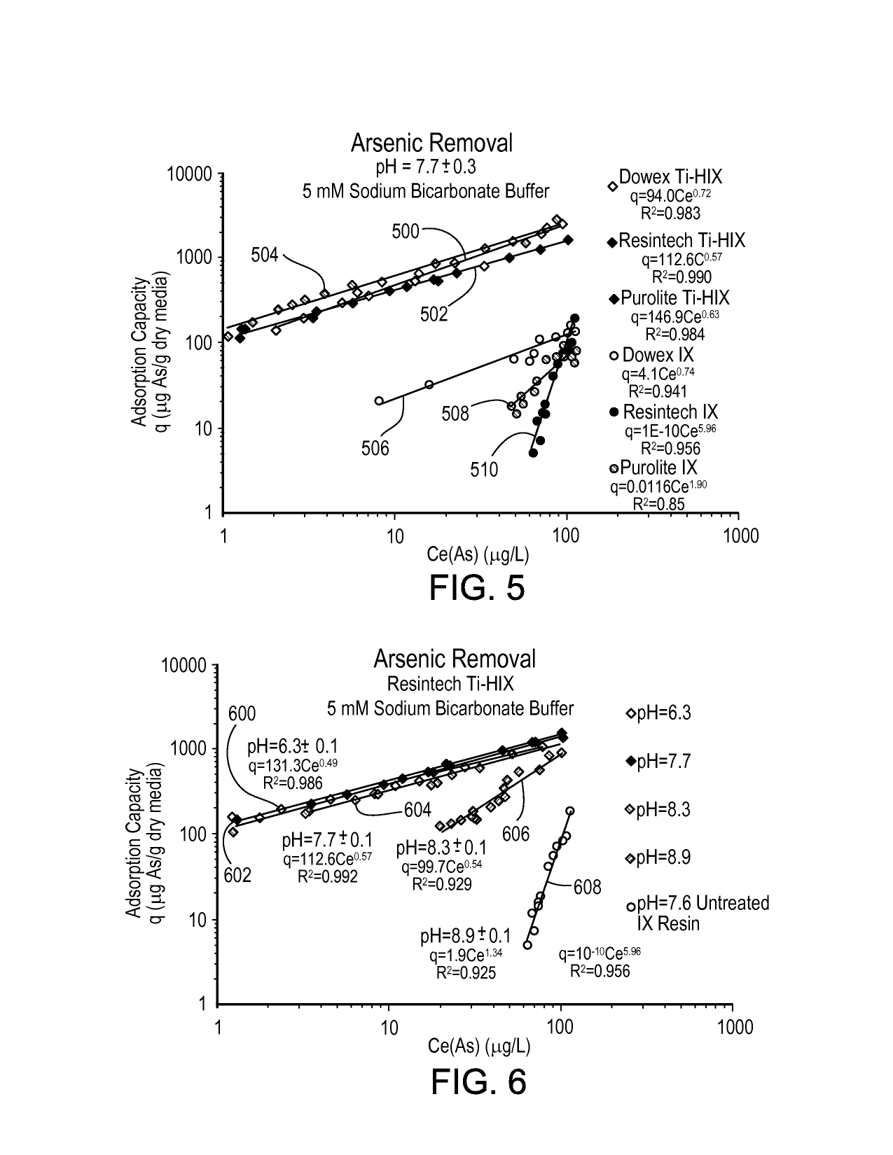

FIG. 5 is a Freundlich isotherm showing arsenic adsorption capacity of the Group 1 hybrid ion-exchange media (plots 500, 502, and 504 for Dowex-HIX, Purolite-HIX, and Resintech-HIX, respectively) and the unimpregnated ion-exchange media (plots 506, 508, and 510 for Dowex-IX, Purolite-IX, and Resintech-IX, respectively) at pH 7.7±0.3 for a 120 μg/L arsenic solution in a 5 mM sodium bicarbonate buffer. Calculated values of Freundlich adsorption capacity parameters including K and l/n for arsenic for each sample as well as the coefficient of determination for each set of data expressed per gram of dry mass of media are shown in Table 3. The Freundlich adsorption intensity parameters (l/n) for all the Ti-HIX media were <1. A value of l/n<1 suggests a low energy of adsorption and good performance in waters with low arsenic concentrations.

TABLE 3
Freundlich isotherm parameters (arsenic adsorption)
for IX and Group 1 Ti-HIX media.

| | K (μg As/g | | |
|---|---|---|---|
| Sample | IX/Ti-HIX media) | 1/n | R² |
| Dowex-HIX | 94.0 | 0.72 | 0.983 |
| Purolite-HIX | 146.9 | 0.63 | 0.984 |
| Resintech-HIX | 112.6 | 0.57 | 0.990 |
| Dowex-IX | 4.1 | 0.74 | 0.941 |
| Purolite-IX | 0.0116 | 1.90 | 0.85 |
| Resintech-IX | 1E−10 | 5.96 | 0.956 |

As seen in FIG. 5, adsorption capacity of the HIX media ranged from about 10 to about 100 times greater than the adsorption capacity of the IX media, based on the equilibrium concentration of arsenic in solution. Grouping of the isotherms suggests that the Ti-HIX exhibit similar arsenic adsorption capacities, with Purolite Ti-HIX exhibiting negligibly higher adsorption capacity and Resintech Ti-HIX exhibiting negligibly lower adsorption capacity under these conditions. The arsenic removal performance of the untreated IX resin was one to three orders of magnitude lower than the hybrid media, indicating that high arsenic adsorption capacity can be attributed to the TiO₂ nanoparticle modification of the media.

Normalized Freundlich capacity parameters expressed per gram of metal (titanium) are shown in Table 4, along with the titanium content of the tested media. For comparison with other metal (hydr)oxide media used in arsenic adsorption under comparable conditions (described in references 1-4 below, all of which are incorporated by reference), Table 4 also summarizes the maximum adsorption capacities expressed per gram of metal (titanium) and estimated for C₀=100 μg As L⁻¹. The estimated maximum adsorption capacities (q₀) for the Ti-HIX media were 16.6 mg As g⁻¹ Ti, 24.9 mg As g⁻¹ Ti, and 27.3 mg As g⁻¹ Ti for the Resintech Ti-HIX, Dowex Ti-HIX, and Purolite Ti-HIX, respectively. These values are several fold higher than values known for other metal (hydr)oxide materials when normalized to gram of metal. The lowest performing Resintech Ti-HIX exhibited almost three times greater adsorption capacity per gram of titanium than commercially available TiO₂ nanopowder, while this factor was even greater for the ferric (hydr)oxide based media.

TABLE 4
Comparison of metal contents and estimated maximum arsenic
adsorption capacity values for Ti-HIX and published values
for other metal (hydr)oxide based media.

| | K (μg | Metal | Est. Max. |
|---|---|---|---|
| | arsenic/g | Content (%) | Adsorption |
| | metal) | (Fe, Zr, | Capacity q₀ |
| Media Type | (L/μg As)^{1/n} | Ti) | (mg As/g) |
| Dowex-HIX | 924.5 | ~10.2 | 24.9 |
| Purolite-HIX | 1520.2 | ~9.7 | 27.3 |
| Resintech-HIX | 1191.7 | ~9.4 | 16.3 |
| TiO₂ nanopowder (pH ~6.7)¹ | NA | ~60 | 7.0 |
| TiO₂ nanopowder (pH ~8.4)¹ | NA | ~60 | 2.8 |
| Zr-GAC (lignite)² | NA | ~12 | 8.6 |
| Zr-GAC (bituminous)² | NA | ~9.5 | 12.2 |
| ZrO₂ nanopowder¹ | NA | ~74 | 3.5 |
| ZrO₂ nanostructured spheres³ | NA | ~74 | 2.4 |
| Fe-GAC (pH ~6.4)⁴ | NA | ~60 | 6.4 |
| Fe-GAC (pH ~8.3)⁴ | NA | ~60 | 1.6 |

¹Hristovski et al., J. Hazard. Mater. 2007, 147 (1-2), 265-274.
²Sandoval et al., J. Hazard. Mater. 2011, 193, 296-303.
³Hristovski et al., Environ. Sci. Technol 2008, 42, 3786-3790.
⁴Hristovski et al., Chem. Eng. J. 2008, 146 (2), 237-243.

FIG. 6 is a Freundlich isotherm showing the effect of pH on arsenic adsorption capacity of the Group 1 Resintech-HIX (5 min mixing, no decantation) in a 120 μg/L arsenic solution in a 5 mM sodium bicarbonate buffer at pH 6.3±0.1 (plot 600), pH 7.7±0.1 (plot 602), pH 8.3±0.1 (plot 604), pH 8.9±0.1 (plot 606) and unimpregnated Resintech-IX (pH 7.6, plot 608). Calculated values of K, l/n, and R² for each pH as well as the coefficient of determination for each set of data are shown in Table 5. For the unimpregnated sample (Resintech-IX), K is 10E-10, l/n is 5.96, and R² is 0.956. As seen in FIG. 6, adsorption capacity of the Resintech-HIX media at pH 6.3, 7.7, and 8.3 exceeded the adsorption capacity of the Resintech-HIX media at pH 8.9 and greatly exceeded the adsorption capacity of the Resintech-IX (unimpregnated) media, based on the equilibrium concentration of arsenic in solution.

TABLE 5
Freundlich isotherm parameters (arsenic adsorption)
for IX and Group 1 Ti-HIX media.

| | K (μg arsenic/g | | |
|---|---|---|---|
| pH | IX/Ti-HIX media) | 1/n | R² |
| 6.3 ± 0.1 | 131.3 | 0.49 | 0.986 |
| 7.7 ± 0.1 | 112.6 | 0.57 | 0.992 |
| 8.3 ± 0.1 | 99.7 | 0.54 | 0.929 |
| 8.9 ± 0.1 | 1.9 | 1.34 | 0.925 |

The arsenate adsorption at pH 6.3 is understood to be higher than that at pH 8.3 at least because the anatase surface is more negatively charged at higher pH. Additionally, at pH 8.3, the HAsO₄²⁻/H₂AsO₄ ratio is about 46 compared to 0.65 at pH 6.3, suggesting that almost all of the arsenate would be present in the more negative form, resulting in greater repulsion forces than at pH 6.3, and consequently causing greater energy required for the adsorption to occur. This increase in required energy for adsorption to occur would be manifested through reduced adsorption capacity and increase in the value of the Freundlich adsorption intensity parameter (l/n) at same sorbent dosages and initial arsenic concentrations. The isotherm data indicates, however, that the adsorption capacity changed little between pH 6.3 and pH 8.3, suggesting that electrostatic repulsion was abated possibly as a result of the Donnan effect created by the positively charged quaternary amine ion exchange groups. The expected trends associated with increase in pH were observed at pH 8.9, which is higher than typically encountered for many metal (hydr)oxides, making the media suitable for arsenic treatment of waters with higher pH.

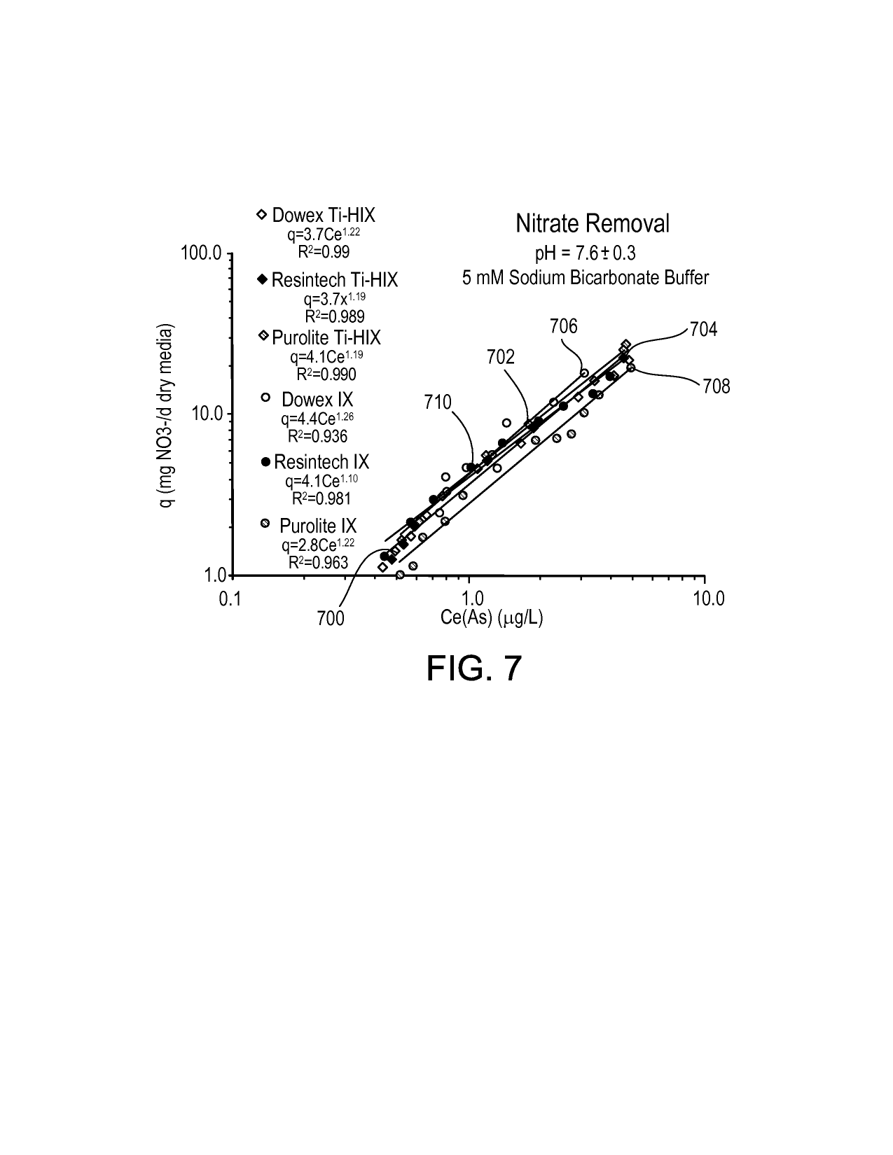

FIG. 7 is a Freundlich isotherm showing nitrate adsorption capacity of the Group 1 HIX media (plots 700, 702, and 704 for Dowex-HIX, Purolite-HIX, and Resintech-HIX, respectively) and the unimpregnated ion-exchange media (plots 706, 708, and 710 for Dowex-IX, Purolite-IX, and Resintech-IX, respectively) at pH 7.6±0.3 in a 5 mg/L nitrate solution in 5 mM sodium bicarbonate buffer. Values of K and l/n for nitrate are shown in Table 6 for each sample as well as the coefficient of determination for each set of data. As seen in FIG. 7, the increased arsenic adsorption capacity of the Ti-HIX media does not substantially affect nitrate adsorption, as compared to the unimpregnated (IX) media. This suggests that the introduction of TiO₂ nanoparticles within the pores of the IX resin did not block the strong base ion-exchange sites responsible for removing the nitrate ions.

TABLE 6
Freundlich isotherm parameters (nitrate adsorption)
for IX and Group 1 Ti-HIX media.

| | K (mg nitrate/g | | |
|---|---|---|---|
| Sample | IX/Ti-HIX media) | 1/n | R² |
| Dowex-HIX | 3.7 | 1.22 | 0.99 |
| Purolite-HIX | 4.1 | 1.19 | 0.99 |
| Resintech-HIX | 3.7 | 1.19 | 0.989 |
| Dowex-IX | 4.4 | 1.26 | 0.936 |
| Purolite-IX | 2.8 | 1.22 | 0.963 |
| Resintech-IX | 4.1 | 1.10 | 0.981 |

The regeneration potential the Resintech SIR 100 based Ti-HIX media was evaluated via short bed adsorber column tests conducted as described in Hristovski et al. 2008, J. Hazard. Mat., 152 (1), 397-406, which is incorporated herein by reference. The tests were used to assess (1) the capacity of the media for removal of inner-sphere forming oxo-anions (phosphate and potentially silica) and nitrate; and (2) the regeneration potential of the media for these constituents during a one step regeneration process with hydrochloric acid. The testing was conducted with NSF 53 Challenge Water at pH=7.5±0.2, and characterized with ˜4.5 mg/L phosphate, ˜25 mg/L Si (e.g., in the form of sodium silicate), and ˜30 mg/L NO₃⁻ to mimic challenging groundwater conditions.

The testing process included 3 steps. In the first step, a bed packed with the Ti-HIX media was operated under the conditions summarized in Table 7 until complete breakthrough was obtained for phosphate (approximately 7.8 L). Then, 14 L of 0.1% HCl was run through the column as a regeneration solution at half the normal operating flow rate. Upon completion of the regeneration process, the first step was repeated under the same conditions as summarized in Table 7.

TABLE 7
Short Bed Column Test conditions for Ti-HIX media

| | |
|---|---|
| Bed Depth (cm) | 4.6 |
| Testing Flow Rate (mL/min) | 16.1 |
| Bed Volume (mL) | 4.4 |
| Column Cross-sectional Area (cm²) | 0.95 |
| Mass of Media in the Packed Bed (dry mass in g) | 1.94 |
| Hydraulic Loading Rate (m³/m²/hr) | 10.2 |

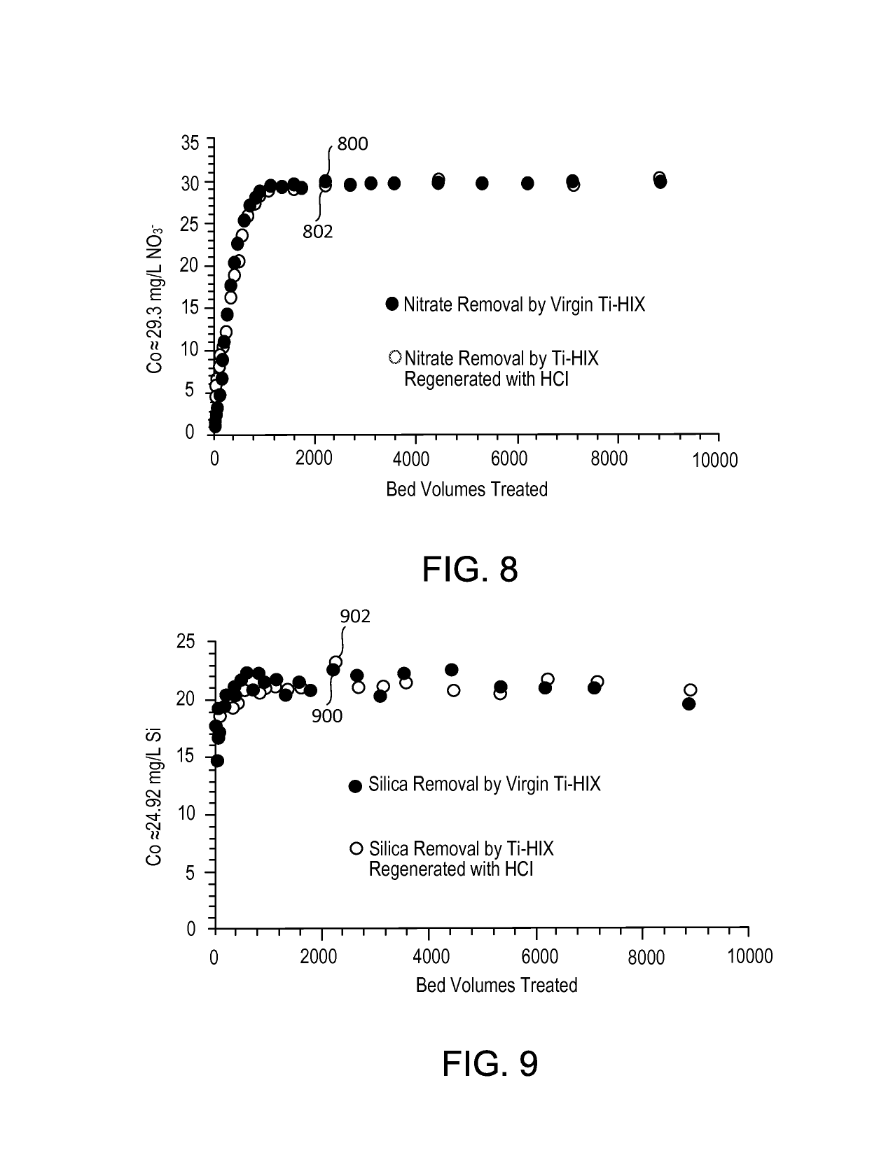

FIG. 8 illustrates the nitrate removal breakthrough curves for virgin and regenerated Ti-HIX media, with solid circles 800 referring to virgin Ti-HIX media and open circles 802 referring to regenerated Ti-HIX media. During the first run, ˜36.3 mg NO₃⁻ (˜18.7 mg NO₃/g dry Ti-HIX media) were removed by the packed bed. Essentially complete regeneration (e.g., >95% or about 100%) regeneration was achieved during the regeneration process, as evidenced by the removal of ˜37.3 mg NO₃⁻ (˜19.2 mg NO₃⁻/g dry Ti-HIX media) by the regenerated media.

FIG. 9 illustrates the silica removal breakthrough curves for virgin and regenerated Ti-HIX media, with solid circles 900 referring to virgin Ti-HIX media and open circles 902 referring to regenerated Ti-HIX media. During the first run, ˜152.6 mg Si (˜78.7 mg Si/g dry Ti-HIX media) were removed by the packed bed. Essentially complete regeneration (e.g., >95% or about 97%) was achieved during the regeneration process, as evidenced by the removal of ˜148.0 mg Si (˜76.3 mg Si/g dry Ti-HIX media) by the regenerated media.

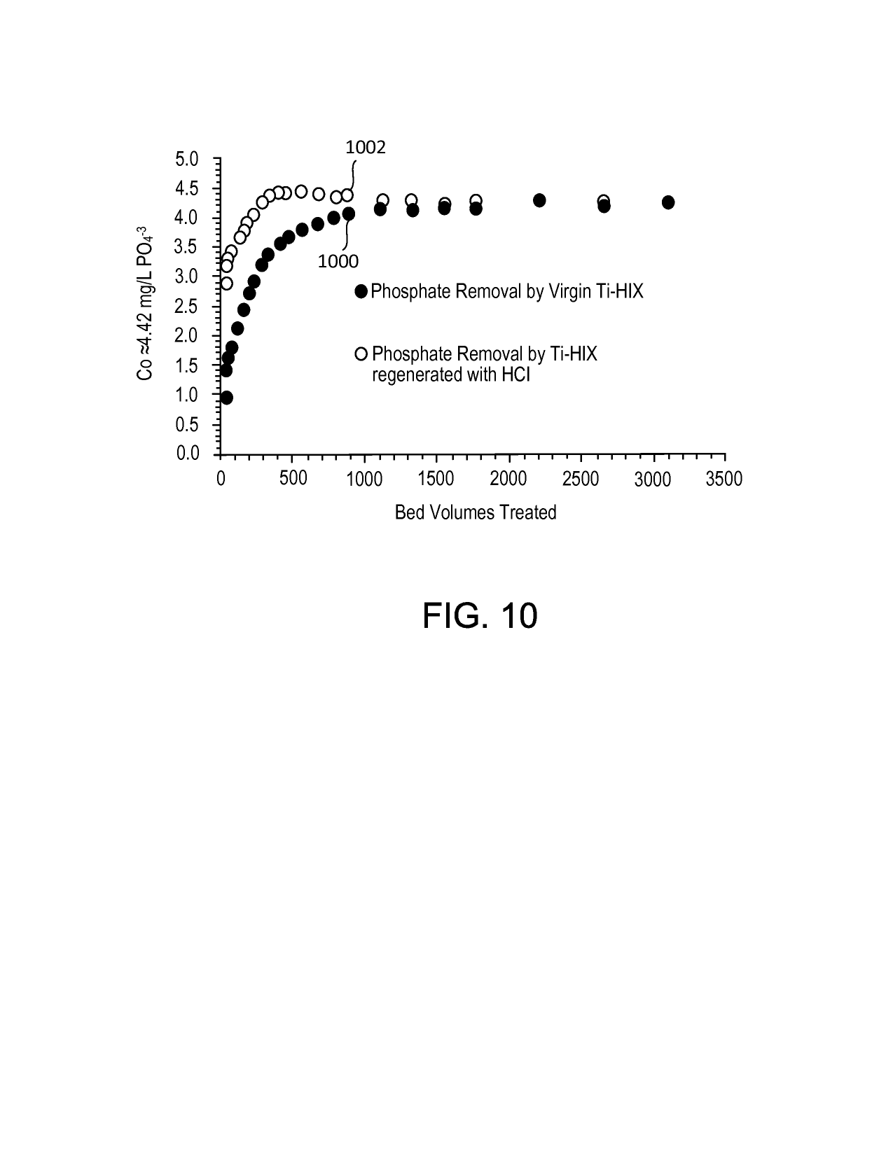

FIG. 10 illustrates the phosphate removal breakthrough curves for virgin and regenerated Ti-HIX media, with solid circles 1000 referring to virgin Ti-HIX media and open circles 1002 referring to regenerated Ti-HIX media. During the first run, ˜5.3 mg PO₄³⁻ (˜2.7 mg PO₄³⁻/g dry Ti-HIX media) were removed by the packed bed. A level of ˜26% regeneration was achieved during the regeneration process, as evidenced by the removal of ˜1.4 mg PO₄³⁻ (˜0.7 mg PO₄³⁻/g dry Ti-HIX media) by the regenerated media.

A number of embodiments have been described. Nevertheless, it will be understood that various modifications may be made without departing from the spirit and scope of this disclosure. Accordingly, other embodiments are within the scope of the following claims. Further modifications and alternative embodiments of various aspects will be apparent to those skilled in the art in view of this description. Accordingly, this description is to be construed as illustrative only. It is to be understood that the forms shown and described herein are to be taken as examples of embodiments. Elements and materials may be substituted for those illustrated and described herein, parts and processes may be reversed, and certain features may be utilized independently, all as would be apparent to one skilled in the art after having the benefit of this description. Changes may be made in the elements described herein without departing from the spirit and scope as described in the following claims.

What is claimed is:

1. A method comprising:
combining ion-exchange media and a TiO²⁺ precursor solution to form a mixture; and
heating the mixture to yield a hybrid ion-exchange media comprising titanium dioxide.

2. The method of claim 1, wherein the ion-exchange media is a strong base or weak base ion-exchange media.

3. The method of claim 1, wherein the hybrid ion-exchange media comprises titanium dioxide particles supported by the ion-exchange media.

4. The method of claim 3, wherein the titanium dioxide particles comprise anatase titanium dioxide nanoparticles.

5. The method of claim 1, wherein the TiO²⁺ precursor solution is an aqueous titanium oxosulfate solution.

6. The method of claim 1, further comprising preparing the TiO²⁺ precursor solution before combining the ion-exchange media with the TiO²⁺ precursor solution.

7. The method of claim 1, heating the mixture to yield a hybrid ion-exchange media comprising titanium dioxide comprises forming titanium dioxide particles on the hybrid ion-exchange media in situ.

8. A method comprising contacting a hybrid ion-exchange media comprising anatase titanium dioxide nanoparticles formed thereon with an aqueous solution comprising an oxo-anion, a strong acid anion, or both, thereby removing the oxo-anion, the strong acid anion, or both from the aqueous solution.

9. The method of claim 8, wherein the oxo-anion comprises arsenate, arsenite, or phosphate.

10. The method of claim 8, wherein the strong acid anion comprises nitrate or perchlorate.

11. The method of claim 8, further comprising contacting the hybrid ion-exchange media with hydrochloric acid, thereby regenerating the hybrid ion-exchange media to yield regenerated hybrid ion-exchange media.

12. The method of claim 11, wherein the regenerated hybrid ion-exchange media is completely regenerated with respect to the strong acid anion.

13. The method of claim 11, wherein the aqueous solution comprises silica, and regenerated hybrid ion exchange media is completely regenerated with respect to silica.

14. A hybrid ion-exchange media comprising anatase titanium dioxide nanoparticles formed in situ in pores of strong base or weak base ion-exchange media.

15. The hybrid ion-exchange media of claim 14, wherein a dimension of the anatase titanium dioxide nanoparticles is between 50 nm and 90 nm.

16. The hybrid ion-exchange media of claim 14, wherein the specific surface area of the anatase titanium dioxide nanoparticles is at least 30 m²/g.

17. The hybrid ion-exchange media of claim 14, wherein a content of the titanium in the anatase titanium dioxide nanoparticles is in a range between 5% and 15% per media dry mass.

18. The hybrid ion-exchange media of claim 14, wherein the adsorption capacity for arsenic expressed per mass of titanium in the hybrid ion-exchange media is in a range between about 15 mg As/g Ti and about 30 mg As/g Ti.

19. The hybrid ion-exchange media of claim 14, wherein the Freundlich adsorption intensity parameter (l/n) of the hybrid ion-exchange media is <1.

20. The hybrid ion-exchange media of claim 14, wherein the hybrid ion-exchange media is completely rengenerable with respect to nitrate and silica.
